(19) United States
(12) Patent Application Publication
(10) Pub. No.: US 2015/0193326 A1
(43) Pub. Date: Jul. 9, 2015

(54) METHOD AND APPARATUS FOR ERROR IDENTIFICATION AND DATA COLLECTION

(71) Applicant: Ford Global Technologies, LLC, Dearborn, MI (US)

(72) Inventors: Doron M. Elliott, Detroit, MI (US); James Dragescu, San Diego, CA (US)

(73) Assignee: Ford Global Technologies, LLC, Dearborn, MI (US)

(21) Appl. No.: 14/148,233

(22) Filed: Jan. 6, 2014

(51) Int. Cl. G06F 11/34; G06F 11/30

(52) U.S. Cl. CPC G06F 11/3476; G06F 11/3072

(57) ABSTRACT

A system includes a processor configured to receive identification of a vehicle-computing process use to track. The processor is also configured to initiate tracking when the identified process is requested and record success data relating to successful uses of the identified process. Further, the processor is configured to record failure data relating to failures resulting from uses of the identified process and report recorded data to a remote server.

### TECHNICAL FIELD

The illustrative embodiments generally relate to a method and apparatus for error identification and data collection.

### BACKGROUND

Within any vehicle computing system, or any computing system for that matter, errors can occur. When these errors occur in vehicle systems, customers may contact a dealer to correct the problem, given the high cost of automobiles. In order to correct the problems, however, errors may need to be replicated by technicians in order to diagnose where the error occurred in a system. This can be difficult, when varied errors are reported. Further, it can be difficult to replicate the conditions under which errors occur.

### SUMMARY

In a first illustrative embodiment, a system includes a processor configured to receive identification of a vehicle-computing process use to track. The processor is also configured to initiate tracking when the identified process is requested and record success data relating to successful uses of the identified process. Further, the processor is configured to record failure data relating to failures resulting from uses of the identified process and report recorded data to a remote server.

In a second illustrative embodiment, a computer-implemented method includes receiving identification of a vehicle-computing process use to track. The method also includes initiating tracking when the identified process is requested. Further, the method includes recording success data relating to successful uses of the identified process and recording failure data relating to failures resulting from uses of the identified process. In addition, the method includes reporting recorded data to a remote server.

In a third illustrative embodiment, a non-transitory computer-readable storage medium stores instructions that, when executed, cause a processor to perform a method including receiving identification of a vehicle-computing process use to track. The method also includes initiating tracking when the identified process is requested. Further, the method includes recording success data relating to successful uses of the identified process and recording failure data relating to failures resulting from uses of the identified process. In addition, the method includes reporting recorded data to a remote server.

### BRIEF DESCRIPTION OF THE DRAWINGS

FIG. 1 shows an illustrative vehicle computing system;

FIG. 2 shows an illustrative example of error condition identification and monitoring setup; and

FIG. 3 shows an illustrative example of error condition monitoring.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

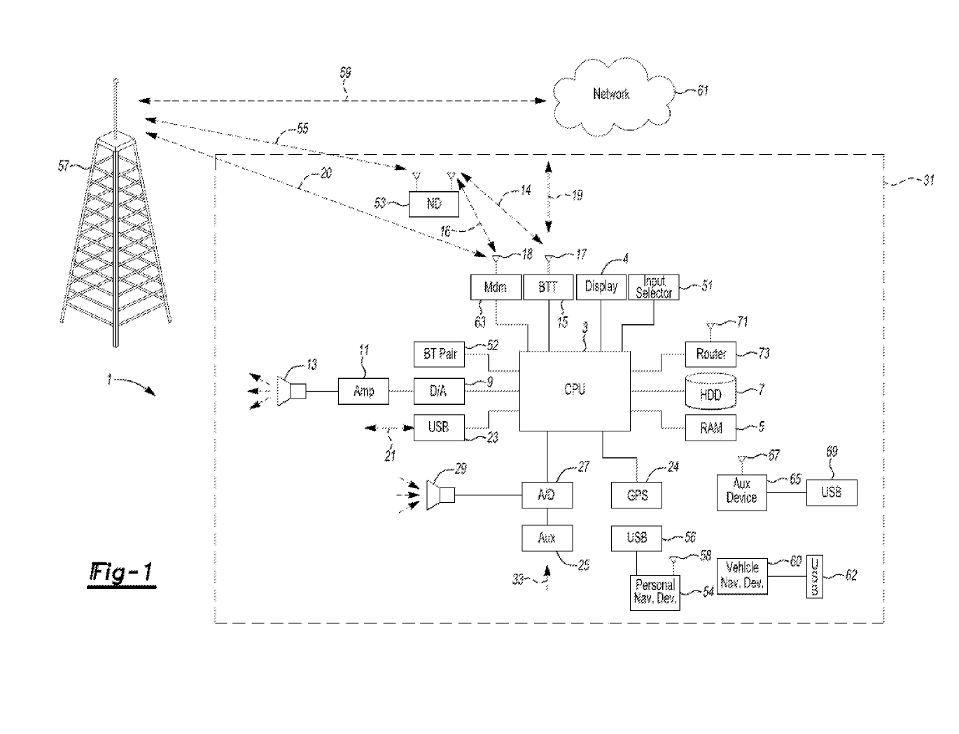

FIG. 1 illustrates an example block topology for a vehicle based computing system 1 (VCS) for a vehicle 31. An example of such a vehicle-based computing system 1 is the SYNC system manufactured by THE FORD MOTOR COMPANY. A vehicle enabled with a vehicle-based computing system may contain a visual front end interface 4 located in the vehicle. The user may also be able to interact with the interface if it is provided, for example, with a touch sensitive screen. In another illustrative embodiment, the interaction occurs through, button presses, audible speech and speech synthesis.

In the illustrative embodiment 1 shown in FIG. 1, a processor 3 controls at least some portion of the operation of the vehicle-based computing system. Provided within the vehicle, the processor allows onboard processing of commands and routines. Further, the processor is connected to both non-persistent 5 and persistent storage 7. In this illustrative embodiment, the non-persistent storage is random access memory (RAM) and the persistent storage is a hard disk drive (HDD) or flash memory.

The processor is also provided with a number of different inputs allowing the user to interface with the processor. In this illustrative embodiment, a microphone 29, an auxiliary input 25 (for input 33), a universal serial bus (USB) input 23, a global positioning system (GPS) input 24 and a BLUETOOTH input 15 are all provided. An input selector 51 is also provided, to allow a user to swap between various inputs. Input to both the microphone and the auxiliary connector is converted from analog to digital by a converter 27 before being passed to the processor. Although not shown, numerous of the vehicle components and auxiliary components in communication with the VCS may use a vehicle network (such as, but not limited to, a controller area network (CAN) bus) to pass data to and from the VCS (or components thereof).

Outputs to the system can include, but are not limited to, a visual display 4 and a speaker 13 or stereo system output. The speaker is connected to an amplifier 11 and receives its signal from the processor 3 through a digital-to-analog converter 9. Output can also be made to a remote BLUETOOTH device such as personal navigation device (PND) 54 or a USB device such as vehicle navigation device 60 along the bi-directional data streams shown at 19 and 21 respectively.

In one illustrative embodiment, the system 1 uses the BLUETOOTH transceiver 15 to communicate 17 with a user's nomadic device 53 (e.g., cell phone, smart phone, personal digital assistant (PDA), or any other device having wireless remote network connectivity). The nomadic device can then be used to communicate 59 with a network 61 outside the vehicle 31 through, for example, communication 55 with a cellular tower 57. In some embodiments, tower 57 may be a WiFi access point.

Exemplary communication between the nomadic device and the BLUETOOTH transceiver is represented by signal 14.

Pairing a nomadic device 53 and the BLUETOOTH transceiver 15 can be instructed through a button 52 or similar input. Accordingly, the central processing unit (CPU) is instructed that the onboard BLUETOOTH transceiver will be paired with a BLUETOOTH transceiver in a nomadic device.

Data may be communicated between CPU 3 and network 61 utilizing, for example, a data-plan, data over voice, or dual-tone multi-frequency (DTMF) tones associated with nomadic device 53. Alternatively, it may be desirable to include an onboard modem 63 having antenna 18 in order to communicate 16 data between CPU 3 and network 61 over the voice band. The nomadic device 53 can then be used to communicate 59 with a network 61 outside the vehicle 31 through, for example, communication 55 with a cellular tower 57. In some embodiments, the modem 63 may establish communication 20 with the tower 57 for communicating with network 61. As a non-limiting example, modem 63 may be a USB cellular modem and communication 20 may be cellular communication.

In one illustrative embodiment, the processor is provided with an operating system including an API to communicate with modem application software. The modem application software may access an embedded module or firmware on the BLUETOOTH transceiver to complete wireless communication with a remote BLUETOOTH transceiver (such as that found in a nomadic device). Bluetooth is a subset of the IEEE 802 PAN (personal area network) protocols. IEEE 802 LAN (local area network) protocols include WiFi and have considerable cross-functionality with IEEE 802 PAN. Both are suitable for wireless communication within a vehicle. Another communication means that can be used in this realm is free-space optical communication (such as infrared data association (IrDA)) and non-standardized consumer infrared (IR) protocols.

In another embodiment, nomadic device 53 includes a modem for voice band or broadband data communication. In the data-over-voice embodiment, a technique known as frequency division multiplexing may be implemented when the owner of the nomadic device can talk over the device while data is being transferred. At other times, when the owner is not using the device, the data transfer can use the whole bandwidth (300 Hz to 3.4 kHz in one example). While frequency division multiplexing may be common for analog cellular communication between the vehicle and the internet, and is still used, it has been largely replaced by hybrids of with Code Domian Multiple Access (CDMA), Time Domain Multiple Access (TDMA), Space-Domian Multiple Access (SDMA) for digital cellular communication. These are all ITU IMT-2000 (3G) compliant standards and offer data rates up to 2 mbs for stationary or walking users and 385 kbs for users in a moving vehicle. 3G standards are now being replaced by IMT-Advanced (4G) which offers 100 mbs for users in a vehicle and 1 gbs for stationary users. If the user has a data-plan associated with the nomadic device, it is possible that the data-plan allows for broad-band transmission and the system could use a much wider bandwidth (speeding up data transfer). In still another embodiment, nomadic device 53 is replaced with a cellular communication device (not shown) that is installed to vehicle 31. In yet another embodiment, the ND 53 may be a wireless local area network (LAN) device capable of communication over, for example (and without limitation), an 802.11g network (i.e., WiFi) or a WiMax network.

In one embodiment, incoming data can be passed through the nomadic device via a data-over-voice or data-plan, through the onboard BLUETOOTH transceiver and into the vehicle's internal processor 3. In the case of certain temporary data, for example, the data can be stored on the HDD or other storage media 7 until such time as the data is no longer needed.

Additional sources that may interface with the vehicle include a personal navigation device 54, having, for example, a USB connection 56 and/or an antenna 58, a vehicle navigation device 60 having a USB 62 or other connection, an onboard GPS device 24, or remote navigation system (not shown) having connectivity to network 61. USB is one of a class of serial networking protocols. IEEE 1394 (firewire), EIA (Electronics Industry Association) serial protocols, IEEE 1284 (Centronics Port), S/PDIF (Sony/Philips Digital Interconnect Format) and USB-IF (USB Implementers Forum) form the backbone of the device-device serial standards. Most of the protocols can be implemented for either electrical or optical communication.

Further, the CPU could be in communication with a variety of other auxiliary devices 65. These devices can be connected through a wireless 67 or wired 69 connection. Auxiliary device 65 may include, but are not limited to, personal media players, wireless health devices, portable computers, and the like.

Also, or alternatively, the CPU could be connected to a vehicle based wireless router 73, using for example a WiFi 71 transceiver. This could allow the CPU to connect to remote networks in range of the local router 73.

In addition to having exemplary processes executed by a vehicle computing system located in a vehicle, in certain embodiments, the exemplary processes may be executed by a computing system in communication with a vehicle computing system. Such a system may include, but is not limited to, a wireless device (e.g., and without limitation, a mobile phone) or a remote computing system (e.g., and without limitation, a server) connected through the wireless device. Collectively, such systems may be referred to as vehicle associated computing systems (VACS). In certain embodiments particular components of the VACS may perform particular portions of a process depending on the particular implementation of the system. By way of example and not limitation, if a process has a step of sending or receiving information with a paired wireless device, then it is likely that the wireless device is not performing the process, since the wireless device would not “send and receive” information with itself. One of ordinary skill in the art will understand when it is inappropriate to apply a particular VACS to a given solution. In all solutions, it is contemplated that at least the vehicle computing system (VCS) located within the vehicle itself is capable of performing the exemplary processes.

Within any vehicle computing system, or any computing system for that matter, errors can occur. When these errors occur in vehicle systems, customers may contact a dealer to correct the problem, given the high cost of automobiles. In order to correct the problems, however, errors may need to be replicated by technicians in order to diagnose where the error occurred in a system. This can be difficult, when varied errors are reported. Further, it can be difficult to replicate the conditions under which errors occur.

Because many customers report errors, however, this information can be used to assist technicians in error data gathering. In the illustrative embodiments, errors can be identified based on data from customers. Systems relating to the errors, and likely causes (e.g., a phone application), can be proactively monitored to detect incidences of error occurrence. By identifying the likely sources of errors in advance, technicians can track data relating to these sources, identify errors and system states as the errors occur, and attempt to build more robust data around the errors so that the errors can be rectified.

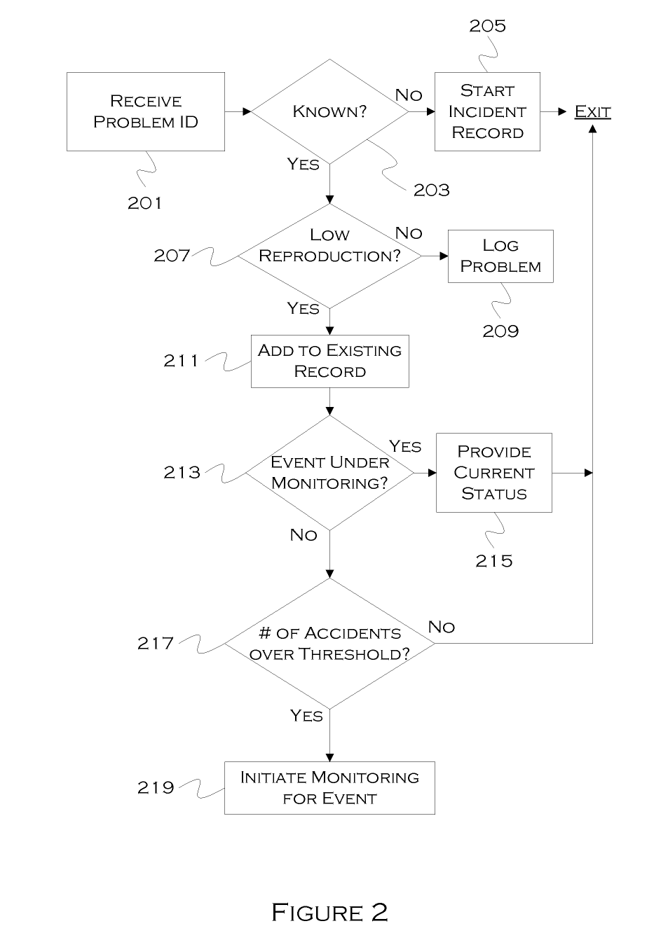

FIG. 2 shows an illustrative example of error condition identification and monitoring setup. As previously noted, identification of the vehicle system states when an error occurs is useful for troubleshooting the error. Of course, this requires that the error be known. Further, it may be useful to examine the system states when an error is not occurring, as a basis for comparison.

One method would be to constantly monitor and record data for all requests passed to and from the system. This, however, would be incredibly work intensive, and would result in a large amount of data saved, that would largely be useless in most situations.

If certain conditions/events/situations/applications are identified, however, it can be much easier to define a basis for recording and data comparison. In the illustrative examples, when consumers identify problematic situations, technicians can determine if these are replicable or not, and, if not, then commonly occurring problems can be tracked in real-time, so that conditions surrounding these problems can be monitored. This may assist in recreating the problems and identifying a solution.

In the illustrative example, the process first receives an identification of the reported problem. This could be input by a customer, or possibly by a dealer/technician. It may be beneficial to allow dealers/service crew to input the problem so that a more standardized approach can be used for problem identification. Or, for example, if a customer inputs a concern, the problem may be further vetted and redefined to be more categorizable. For example, if a phone application is creating the same error in multiple vehicles, it might be useful to input the problem in a standardized format so the problem can be recognized as a common problem as opposed to multiple problems which may appear to stem from a different source.

In this example, the problem is received in an identifiable format which can be compared to other known problems 201. The system can be used to identify specific errors, errors occurring with an application generally, or any other common denominators. The process checks to see if the problem is known in some identifiable manner 203. If the problem was previously unknown, a new incident record is created and the problem is recorded as a new problem 205.

If the problem is currently known, meaning, for example, that the problem has previously been identified, the process checks the current record for that problem to see if the problem has a low reproduction rate 207. It may not be necessary to record data for problems that are easily replicable, since those problems can be more easily addressed and trouble-shot in a controlled environment. In this example, for illustrative reasons, the primary concern is problems with high incident rates and low replicability. If the problem is easily replicable, the process records the incident report and then exits 209.

If the problem has been identified as a problem that is not easily replicable, then the process may add the current incident report to the existing record 211. Since there may be a myriad of highly uncommon problems, caused by very specific situations, it may not be desirable to track data related to all these problems initially. Especially with a new system, it may be desirable to primarily focus efforts on commonly occurring problems. As the more common problems are addressed, thresholds for commonality may be lowered in order to focus on the more esoteric problems so that, eventually, almost all problems can be addressed.

Once the problem has been added to the incident record, the process checks to see if this problem has been identified as one that is currently under monitoring 213. For example, the problem may have already been identified as a high incident problem, and thus flagged for monitoring. If the problem has been identified as a problem being monitored, the process may have some useful feedback data to be provided to the problem-observer. In this case, data from the technicians working on the problem may be reported back to the user 215.

The user may receive, for example, an incident report stating where the progress of problem solution currently is. For example, the problem could be identified as patched, under observation, etc., and an estimated repair date could even be provided if available. This could help prevent the user from re-reporting the problem at a later date, if the user knows that a repair is likely upcoming.

If the event/problem is not yet under monitoring, the process may check to see if, with the addition of the report, a reported number of incidents is over a threshold 217. Setting a number-of-incidents threshold is just one exemplary means of identifying common problems for being addressed. In this example, the process counts the number of incidents to identify commonly occurring problems. The threshold can be varied depending on how focused the inquiry should be. For example, the threshold could be set at 10,000 incidents when a system is new, so that only largely occurring problems are identified and focused on in the early stages. This number could be pared back to, for example, 500 incidents as the more commonly occurring problems are addressed.

The pare back could even be automatically dynamic in nature, such that, if no number of problems over a current threshold occurs within a given time period, the number could be automatically lowered. Once a certain number of incidents begins to meet the new threshold, that threshold could be held in place until problems cease to rise to that new level of occurrence, etc.

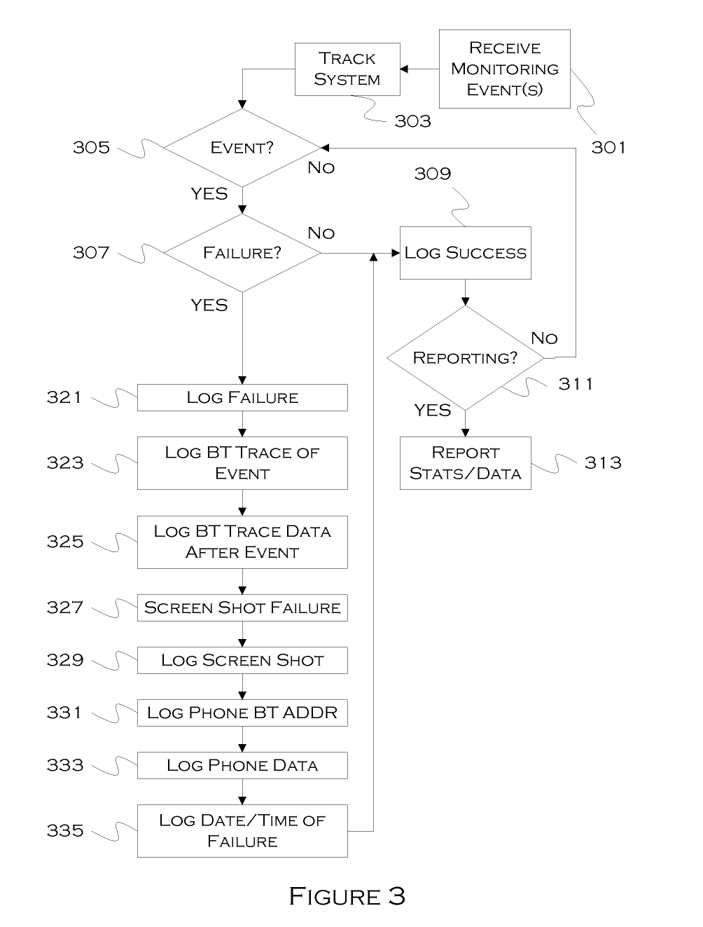

If any incident pushes the number of reported incidents over the threshold, the process may begin to initiate monitoring for the event 219. The process of monitoring will be discussed in greater detail with respect to FIG. 3.

FIG. 3 shows an illustrative example of error condition monitoring. This is just one non-limiting example of how monitoring may be performed. In this illustrative example, the process receives one or more events that may require monitoring 301. The process runs locally on the vehicle in this example, and the monitoring is performed at the vehicle.

For each appropriate event, the process will monitor the incidents of the event, including both successful and unsuccessful utilization of the process/application/request that causes the reported error. In some incidents, the use of an application may be monitored, in other cases, it may be the initiation of a process within the computing system or within an application. Technicians may identify the specific process(es) to be monitored.

Once at least one process has been identified for monitoring, the process tracks use of the vehicle computing system 303 for use of the identified process(es). Once an event (e.g., the use of the process/application) occurs 305, the process checks to see if a failure is associated with the event 307.

If there is no failure, the process will log the success associated with the event 309. Logging success includes recording any information that may be relevant for comparison to event failure data. This can include, but is not limited to, phone brand, provider, connection type, model, software version, application version, computing system states, data usage, type of request, etc. The success information, compared to the failure information, can be helpful in aiding techs in identifying the cause(s) of the problems.

If any reporting is desired 311, the process can, at this time, report any statistics or data that has been previously saved/recorded 313. This information can relate to the present occurrence of the event, and to any previously saved and unreported data. Since an internet connection to a remote server may not always be available, the process may store the data locally until such time as reporting is desired and/or possible.

If there is a failure associated with any tracked process/application 307, the process may create a log of the failure 321. This log will be useful to technicians in identifying any problems associated with the account, especially with respect to problems that are not easy to recreate based on reported incidents from customers.

The process will log Bluetooth tracking of the failure event 323. In this example, the process also logs Bluetooth tracking data after the event 325. In addition, a screen shot of the failure or of the screen state at the time of failure may be taken 327 and logged 329. Further, the Bluetooth phone address may be logged 331. Also, phone data (version, brand, model, provider, software versions, application versions, connection type, etc.) may be logged 333. And, in this example, a date and time of failure may also be logged 335, as well as any other relevant information.

This data, and any other logged data, may be useful in either troubleshooting the reported error(s) and/or recreating the errors. Using the data, technicians can hopefully fix the problems that they are having difficulty recreating, so that future users will not suffer from the same errors. By identifying problems for tracking in advance, technicians can engage in specific data gathering for use in troubleshooting. By refining the problem identification, data relating specifically to the various problems that are difficult to replicate, and also that may be common, can be gathered for use in fixing the problem(s).

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A system comprising:
a processor configured to:
receive identification of a vehicle-computing process use to track;
initiate tracking when the identified process is requested;
record success data relating to successful uses of the identified process;
record failure data relating to failures resulting from uses of the identified process; and
report recorded data to a remote server.

2. The system of claim 1, wherein the recorded success data corresponds to data recorded for failures.

3. The system of claim 1, wherein the recorded failure data includes a vehicle computing system screen shot.

4. The system of claim 1, wherein the recorded failure data includes phone data.

5. The system of claim 1, wherein the recorded failure data includes time and date data.

6. The system of claim 1, wherein the recorded failure data includes a Bluetooth phone address.

7. The system of claim 1, wherein the recorded failure data includes Bluetooth trace data following a failure.

8. A computer-implemented method comprising:
receiving identification of a vehicle-computing process use to track;
initiating tracking when the identified process is requested;
recording success data relating to successful uses of the identified process;
recording failure data relating to failures resulting from uses of the identified process; and
reporting recorded data to a remote server.

9. The method of claim 8, wherein the recorded success data corresponds to data recorded for failures.

10. The method of claim 8, wherein the recorded failure data includes a vehicle computing system screen shot.

11. The method of claim 8, wherein the recorded failure data includes phone data.

12. The method of claim 8, wherein the recorded failure data includes time and date data.

13. The method of claim 8, wherein the recorded failure data includes a Bluetooth phone address.

14. The method of claim 8, wherein the recorded failure data includes Bluetooth trace data following a failure.

15. A non-transitory computer-readable storage medium, storing instructions that, when executed, cause a processor to perform a method comprising:
receiving identification of a vehicle-computing process use to track;
initiating tracking when the identified process is requested;
recording success data relating to successful uses of the identified process;
recording failure data relating to failures resulting from uses of the identified process; and
reporting recorded data to a remote server.

16. The storage medium of claim 15, wherein the recorded success data corresponds to data recorded for failures.

17. The storage medium of claim 15, wherein the recorded failure data includes phone data.

18. The storage medium of claim 15, wherein the recorded failure data includes time and date data.

19. The storage medium of claim 15, wherein the recorded failure data includes a Bluetooth phone address.

20. The storage medium of claim 15, wherein the recorded failure data includes Bluetooth trace data following a failure.
